(19) United States
(12) Patent Application Publication
(10) Pub. No.: US 2009/0044713 A1
(43) Pub. Date: Feb. 19, 2009

(54) Gravure Printing-Form Sleeve and Production Thereof

(75) Inventors: Hartmut Fuhrmann, Bobingen (DE); Mladen Frlan, Gersthofen (DE)

Correspondence Address: COHEN, PONTANI, LIEBERMAN & PAVANE LLP, 551 FIFTH AVENUE, SUITE 1210, NEW YORK, NY, 10176, US

(73) Assignee: MAN Roland Druckmaschinen AG, Offenbach am Main (DE)

(21) Appl. No.: 12/084,399

(22) PCT Filed: Oct. 28, 2006
(86) PCT No.: PCT/EP2006/010396

§ 371 Date: Apr. 30, 2008

(30) Foreign Application Priority Data
Nov. 2, 2005 (DE) 10 2005 052 159.2

(51) Int. Cl. B41F 13/10; B21D 33/00

(52) U.S. Cl. 101/375; 29/17.1

(57) ABSTRACT

To develop a novel gravure printing form, which is simple to produce and is highly suitable with respect to a variation of formats, the invention discloses the use of a steel carrier sleeve in the form of a master sleeve. The initial form of said sleeve is a rectangular plate with a wall thickness of between 0.1 mm and 0.4 mm, which is given the desired hollow cylindrical form by bending, the opposing edges of the plate being permanently joined together, in particular by welding. A copper gravure layer is applied to the outer surface of the plate, a basic grid being etched into the copper gravure layer by means of a laser gravure process. The basic grid is then uniformly filled with a liquefiable substance to form the gravure printing form and the filler material is removed from the depressions of the basic grid to produce the required image.

The invention pertains to a gravure sleeve and to its production.

The gravure printing process is an especially simple process, which is characterized in that the inking does not first have to reach a state of equilibrium as is usually the case in offset single-color systems; on the contrary, it offers the substrate the correct amount of ink almost immediately. A very high level of print quality is achieved with gravure printing, and an extremely wide variety of substrates can be printed. Counting against this advantage is the considerable amount of effort usually required to produce a gravure form. In particular, when the printed image is to be changed, it is necessary to use hoisting device to remove the massive, heavy cylinders from the printing press. These gravure cylinders must then be stored or returned to the gravure form production process. The gravure form can be produced in a location completely different from that in which the printing press is located. The effort required to produce the gravure form can therefore also include a considerable amount of transport work; and even if the gravure form is produced at the same location as that where the form is used for printing, the heavy weight of a gravure cylinder makes it very difficult to transport the cylinder through the individual steps of the process required to produce it.

To solve the weight problem, thin-walled nickel sleeves are already being offered, which are provided with a layer of engraving copper and engraved like conventional gravure forms. To produce these nickel sleeves, however, a cylinder is required, on which the nickel is first deposited to the desired sleeve thickness of 0.2-0.4 mm, whereupon the engraving copper is deposited on the nickel. As a result of a separation layer between the cylinder body and the nickel layer, the electrolytically grown nickel can then be pulled off the cylinder as a thin, seamless tube. This production method becomes problematic when sleeves with different circumferences are required, which is a frequent occurrence.

The production of a gravure sleeve in cases where a gravure form must be produced with a new circumference not already on hand therefore comprises the production of a first cylinder, which holds the finished, ready-to-print gravure sleeve and which is installed in the printing press. The processing steps such as turning to size, polishing, and engraving can be performed on this first cylinder, whereas the galvanic production of the nickel sleeve, followed by galvanic coating of the engraving copper, are performed on a second cylinder.

Processes for the simplified production of erasable and reusable gravure forms and the devices necessary for implementing them are also known from, for example, EP 0 730 953 B1.

In that document, a prestructured blank gravure form with a basic screen designed to accept at least the maximum amount of ink to be transferred is filled in a first step with a filler substance by an applicator device. The filler substance can be a thermoplastic resin or a wax, a varnish, or a crosslinkable polymer melt or solution, which is also called a “reactive system” and which is characterized by an extremely high degree of abrasion resistance. The surface of the gravure form is then essentially smooth. Then the substance used as a filler is removed from the cells in accordance with the desired image by the thermal energy of an image-point transfer device. Now the gravure form can be inked by means of an inking system, so that the substrate can be printed by the gravure process. After printing is complete, the surface of the gravure form is regenerated by cleaning off the ink residues; by removing the filler substance, preferably completely, from the prestructured cells; and by filling the cells uniformly again. The filler substance can be removed from the prestructured cells by means of a heat source and/or an air-blast device or a suction device.

In principle, ablation imaging can address areas (image pixels) which are smaller than the elements of the basic screen of the blank gravure form, and in particular ablation imaging can even be carried out essentially independently of the basic screen. Nevertheless, ablation imaging can also conform to the basic screen; that is, it can stand in a certain geometric relationship to it. In the ideal case, the ablation imaging step structures the cells of the basic screen in the manner required by process technology.

It is also known from DE 44 32 814 A1 that a carrier sleeve for supporting printing and transfer forms can be made of metallic material, which starts out as a rectangular piece of thin sheet metal, which is bent into the desired hollow cylindrical form. Then the two facing edges of the sheet are permanently connected to each other, preferably by welding. The external surface of the welded carrier sleeve is machined to produce a homogeneous and uninterrupted lateral surface. The cost of producing a welded and machined precision sleeve is much lower that the cost of producing sleeves with galvanically deposited nickel.

Against this background, the task of the invention was to develop a new gravure form, which, in one embodiment, can also be erased and reused, which is easy to produce, and which offers considerable advantages over the prior art with respect to variability of format.

This task is accomplished by a gravure form of Claim 1 and by the process for producing it according to Claim 10.

According to the invention, the previously described second cylinder, on which the nickel sleeve is galvanically applied, is eliminated by the use of a welded steel sleeve, in that welded steel sleeves such as those described in DE 44 32 814 A1 are used instead of sleeves with galvanically deposited nickel.

A steel sleeve of this type with a typical wall thickness of 0.1-0.4 mm is produced with the desired circumference out of thin-walled sheet metal of the desired thickness and then welded. This sleeve can then replace the galvanically produced nickel sleeve in the production of gravure forms. If suitable material has been selected for the welded steel sleeve, the engraving copper layer required for the gravure form can be applied directly to the welded sleeve; or, alternatively, the copper can be applied on top of suitable intermediate layers.

The engraving copper layer also covers the weld, and thus a gravure form suitable for continuous printing is obtained.

Although a precise circular geometry of the cross section of the welded steel sleeve is not necessary for the deposition of the engraving copper layers, the circularity of the easily deformable steel sleeve can be guaranteed by providing circular covers, for example, or by the use of other geometries which define a circle, such as sets of spoke-like rods, the ends of which lie on a circle, which are much easier to work with than the previously described second cylinder. In addition, the handling of the sleeve during the copper-plating process is made much easier by the light weight of the sleeve.

As previously explained, an erasable and reusable gravure form is described in EP 0 730 953 B1, which can also be designed as a sleeve. In comparison to a gravure cylinder, the weight of a gravure form of this type is reduced to about 1 kg to 2 kg, whereas a gravure cylinder can easily weigh 100 kg, depending on its size.

According to the invention, therefore, the gravure form is built up by means of a steel carrier sleeve in the form of a sleeve, which starts out as a rectangular piece of sheet metal with a thickness of 0.1-0.4 mm, which is bent into the desired hollow cylindrical shape. The two facing edges of the sheet are permanently connected to each other, preferably by welding, and then a layer of engraving copper is applied to the external surface of the shell. A raster image or a basic screen is now machined into the engraving copper layer. To obtain an erasable and reusable gravure form, the basic screen is filled uniformly with a filler substance, and the filler material is then removed from the cells of the basic screen.

According to the invention, a gravure form of this type is produced by pulling a strip of thin steel sheet with a thickness in the range of 0.1-0.4 mm from a coil, and, while it is still in the flat state, by cutting the support sheet to the dimensions corresponding to the circumference and width of the mounting cylinder to be used. The support sheet is bent into the desired hollow cylindrical shape, and the two facing edges of the support sheet are permanently connected to each other, preferably by welding, whereupon and a layer of engraving copper is galvanically deposited on the external lateral surface of the steel carrier sleeve. The engraving copper layer is turned to size and polished. To create a gravure form by the known engraving techniques, such as mechanical engraving or laser etching/engraving, the image to be printed is engraved into the layer of engraving copper. To produce an erasable and reusable gravure form, a basic screen is engraved, preferably by laser engraving; the cells of the basic screen are filled uniformly with a filler substance by an applicator device. Then the filler material is removed from the cells by an image-point transfer device.

The sheet metal which is used to produce the tubular gravure sleeve can also be provided in the form of a strength-providing steel sheet to which a layer of engraving copper, which will be engraved, has already been laminated. It is preferable, however, for the layer of engraving copper to be galvanically deposited onto the tubular carrier sleeve.

The applied layer of engraving copper preferably covers the weld of the carrier sleeve completely, so that the inventively designed gravure form allows the application of 360° print images (continuous printing), as conventional in, for example, the printing of packaging and decorative materials.

Before the engraving copper layer is applied to the carrier sleeve, an intermediate layer can be applied to the sleeve first to assist the adhesion and the course of the engraving copper deposition process. In addition, devices for holding the carrier sleeve must also be present for the other process steps, namely, the steps required to fabricate the conventional gravure form or the master sleeve for an erasable and reusable gravure form, including:

(a) the galvanic application of the copper layer,

(b) the turning of the copper layer to size,

(c) the polishing of the copper layer,

(d) the application of the basic screen, and

(e) the galvanic application of a layer of chromium, and also for the process steps required to produce/regenerate the reusable gravure form, such as:

(f) the removal of the filler material (omitted if this is the first time the form is being used),

(g) the application of fresh filler material,

(h) the curing of the filler material,

(i) the polishing of the reusable gravure sleeve,

(j) imaging, and

(k) printing.

The various process steps impose different requirements on these devices.

Device for the Process Steps which Impose Special Requirements on the Stability Of the Circular Cross Section of the Gravure Sleeve:

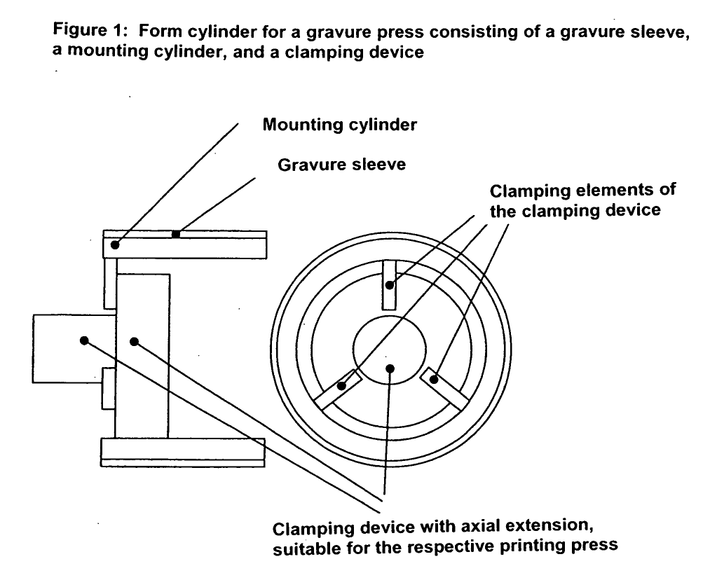

For turning-to-size (b) and the polishing processes (c) and (i), as well as for printing (i) and possibly—depending on the design—for the filling process (g) and the application of the basic screen (d), a mounting of extremely high dimensional stability is needed for the gravure sleeve, because, during these processes, forces act on the sleeve which can cause undesirable out-of-roundness in the cross section of the sleeve. For these process steps, the gravure sleeve can be held by simple sleeves which have been fabricated specifically for a certain diameter and which therefore have fixed diameters or by sleeves with diameters which can be varied within certain limits. Both of these have a standardized internal geometry, which is mounted on a universal clamping device good for all formats (see FIG. 1). The same combination of sleeve and mounting device can also be used in a corresponding manner to hold the sleeve—in the form of an impression cylinder—in the printing press. As a result, when gravure sleeves with different circumferences must be produced, the effort required to adapt the circumference of the gravure form to the product to be printed is reduced considerably. For different cylinder circumferences and thus formats, only one mounting device, i.e., impression cylinder, adapted to the printing press in question, is necessary to hold the sleeves required for different formats.

Mounting Device for Process Steps which Impose No Special Requirements on the Stability of the Circular Cross Section of the Gravure Sleeve:

For the process steps (a) galvanic application of the copper layer, (d) application of the basic screen, (e) galvanic application of the chromium layer, (f) removal of the old filler material, and possibly (g) application of the new filler material, (h) curing of the filler material, and (0) imaging the gravure form, the gravure sleeve does not have to be mounted on a stable cylinder or on a dimensionally stable sleeve, because these processes transmit no mechanical forces or only weak forces to the sleeve.

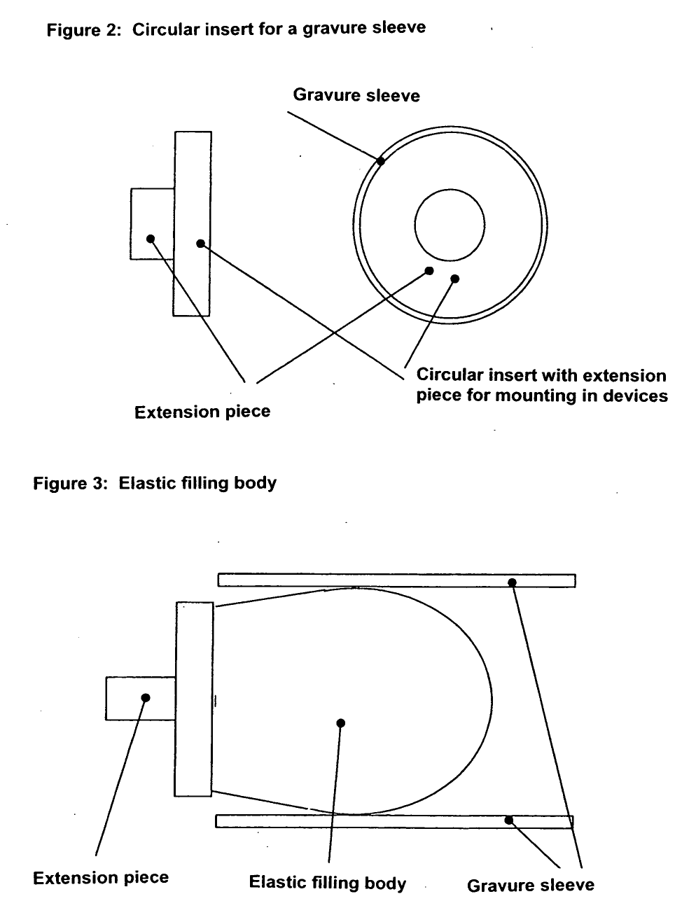

For these processes, known clamping systems, either hydraulic ones or those operating with compressed air, can be used, which can hold the gravure sleeve directly. It is also possible to place a circular insert, which can be easily fabricated with sufficient precision, into each end of the sleeve, and these inserts can then be held in place by clamping systems such as those used in turning or grinding machines (see FIG. 2). If necessary, this circular insert can comprise aids for clamping or fastening, which prevent the inserts from falling out during the handling of the gravure sleeve. Another possibility is to use an elastic or inflatable filling body, which exerts the same force on the sleeve over the entire circumference of the sleeve cross section and thus produces or maintains the circularity of the sleeve (see FIG. 3). A filling body of this type can be very light in weight, so that the sleeve, including the filling body, can be handled very easily as it is transferred from one process to another, and at the same time the circularity of the sleeve cross section remains sufficiently preserved.

Especially during the process step of printing, it is possible for ink to intrude between the sleeve and the variable-diameter sleeve and between the sleeve and the universal device good for all formats. This ink can interfere with the easy separation of the gravure sleeve from the sleeve and from the universal clamping device good for all formats. Several measures can be taken to prevent this:

sealing the intermediate space between the gravure sleeve and the variable-diameter sleeve or sealing the intermediate space between the variable-diameter sleeve and the universal clamping device good for all formats, or

designing the variable-diameter sleeve and the universal clamping device good for all formats in such as way that the intermediate space between this sleeve and this clamping device lies above the level of the ink in the ink trough of the printing press.

The inventive gravure form, as described above, has a wall thickness in the range of 0.1-0.5 mm and is pushed onto a dimensionally stable mounting tube with a wall thickness of >5 mm, where the outside diameter of the mounting tube is 0.1-0.5 mm smaller than the inside diameter of the sleeve-shaped gravure form. The mounting tube has openings in its circumference through which compressed air can be sent, so that the process of pushing the gravure sleeve onto the tube is assisted by the formation of an air cushion between the mounting tube and the gravure form.

According to another possibility for mounting the gravure sleeve on a mounting tube, the outside diameter of the mounting tube is adapted to the inside diameter of the gravure sleeve in such a way that a nonpositive connection is established between the mounting tube and the sleeve. This is achieved by hydraulically or pneumatically actuated circumferential segments or by an elastic deformation of the circumference of the mounting tube caused by hydraulic or pneumatic pressure or by thermal expansion. The inside diameter of the mounting tube is designed to fit a universal clamping device. The universal clamping device is sufficient at the same time to meet the requirements of the bearings by which the gravure cylinders are mounted in a gravure press, and it can therefore be installed in the press together with the carrier sleeve or the mounting tube of the gravure sleeve and the gravure sleeve itself as a complete gravure cylinder. The intermediate space between the universal clamping device and the mounting tube is preferably sealed to prevent the intrusion of ink.

1-18. (canceled)

19. A gravure printing assembly comprising a gravure sleeve formed by a rectangular piece of steel sheet having a pair of parallel edges and a thickness of 0.1-0.4 mm, wherein the piece of steel sheet is bent into a cylindrical shape and the parallel edges are joined together by a weld to form a steel carrier sleeve having an outer cylindrical surface, the gravure sleeve further comprising a layer of engraving copper on the outer cylindrical surface.

20. The gravure printing assembly of claim 19 wherein the layer of engraving copper covers the outer cylindrical surface in entirety, including the weld.

21. The gravure printing assembly of claim 19 further comprising a mounting tube having a wall thickness of >5 mm, wherein the mounting tube has an outside diameter that can be adapted to the inside diameter of the steel carrier sleeve so that a non-positive connection can be made between the mounting tube and the carrier sleeve.

22. The gravure printing assembly of claim 19 further comprising a mounting tube having a wall thickness of >5 mm, wherein the mounting tube has an outside diameter which is less than the inside diameter of the steel carrier sleeve, the mounting tube having openings for compressed air to provide a cushion when the carrier sleeve is placed on the mounting tube.

23. The gravure printing assembly of claim 22 wherein an intermediate space present between the mounting tube and the carrier sleeve is sealed against intrusion of ink.

24. The gravure printing assembly of claim 21 further comprising a clamping device fitted inside the mounting tube to form a gravure cylinder that can be used in a gravure press.

25. The gravure printing assembly of claim 19 further comprising a pair of circular inserts fitted inside the steel carrier sleeve and having extensions for mounting on the a device used to produce a gravure sleeve by operations on the layer of engraving copper.

26. The gravure printing assembly of claim 19 further comprising an elastic filling body received inside the steel carrier sleeve, the elastic filling body having extensions for mounting on a device used to produce a gravure sleeve by operations on the layer of engraving copper, the elastic filling body exerting a uniform radial force on the carrier sleeve so that it assumes a circular cross section.

27. The gravure printing assembly of claim 26 wherein the elastic filling body is under pneumatic pressure.

28. A method for producing a gravure printing sleeve, the method comprising:
pulling a strip of steel sheet from a coil, the sheet having a thickness of 0.1-0.4 mm;
cutting a rectangular piece of steel sheet from the strip, the rectangular piece having dimensions corresponding to the circumference and length of a mounting tube;
bending the rectangular piece of steel sheet into a cylindrical shape having mutually facing edges;
joining the mutually facing edges together by welding to form a steel carrier sleeve having an outer cylindrical surface; and
galvanically coating the outer cylindrical surface of the carrier sleeve with a layer of engraving copper to form a gravure sleeve.

29. The method of claim 28 further comprising:
turning the copper layer to size;
polishing the copper layer;
producing a basic screen in the copper layer, the basic screen corresponding to printing form content to be printed; and
galvanically coating the basic screen with a layer of chromium.

30. The method of claim 29 further comprising:
filling the basic screen with filler material;
curing the filler material;
polishing the gravure sleeve;
imaging the gravure sleeve by selective removal of filler material; and
printing.

31. The method of claim 30 further comprising mounting the gravure sleeve on a dimensionally stable mounting tube for at least the polishing steps and the printing step.

32. The method of claim 31 wherein the step of filling the basic screen is carried out on the dimensionally stable mounting cylinder.

33. The method of claim 31 further comprising mounting the gravure sleeve on a mounting device which renders the gravure sleeve dimensionally unstable for the steps of galvanically coating the outer cylindrical surface, producing the basic screen, galvanically coating the basic screen with a layer of chromium, filling the basic screen with filler material, curing the filler material, and imaging.

34. The method of claim 33 wherein the mounting device comprises a pair of circular end pieces which are inserted in opposite ends of the gravure sleeve to force the dimensionally unstable gravure sleeve into a shape having a circular cross-section, said end pieces being designed to mount for rotation.

35. The method of claim 34 wherein the circular end pieces comprise means for preventing the end pieces from falling our of the dimensionally unstable gravure sleeve during handling.

36. The method of claim 33 wherein the mounting device comprises an elastic filling body received in opposite ends of the gravure sleeve, the elastic filling body exerting a uniform radial force on gravure sleeve so that it assumes a circular cross section.
